(19) United States
(12) Patent Application Publication
(10) Pub. No.: US 2017/0222379 A1
(43) Pub. Date: Aug. 3, 2017

(54) RECEPTACLE FOR CONNECTING A MULTI-LANE OR ONE-LANE CABLE

(71) Applicant: HEWLETT PACKARD ENTERPRISE DEVELOPMENT LP, Houston, TX (US)

(72) Inventors: Kevin B LEIGH, Montgomery, TX (US); John NORTON, Houston, TX (US); George D MEGASON, Sr., Spring, TX (US)

(21) Appl. No.: 15/500,526

(22) PCT Filed: Sep. 26, 2014
(86) PCT No.: PCT/US2014/057858

§ 371 Date: Jan. 30, 2017

(51) Int. Cl. H01R 27/00; H01R 29/00

(52) U.S. Cl. CPC H01R 27/00; H01R 29/00

(57) ABSTRACT

One example of a system includes a receptacle including a plurality of bays. Each bay of the receptacle supports 1-lane of network communications. The receptacle is to connect to a multi-lane cable to provide a multi-lane port or connect to a plurality of 1-lane cables to provide a plurality of 1-lane ports.

### BACKGROUND

High-radix network switch modules may support a high number of connectors on their faceplates. Network port standards allow 1-lane and wider ports (e.g., 12-lane for CXP), and wider ports use larger connectors and thus fewer connectors on the faceplate. Different applications use different port bandwidth. Traditionally, either 1-lane (e.g., Small Form-Factor Pluggable (SFP)) or 4-lane (e.g., Quad Small Form-Factor Piuggable (QSFP)) ports predominate the Ethernet industry. As the bandwidth per lane has reached 10 Gbps, however, not every system can take advantage of QSFP 4-lane ports.

### BRIEF DESCRIPTION OF HE DRAWINGS

FIGS. 1A-1C illustrate examples of systems including modularly scalable connectors and cables.

FIG. 2 illustrates examples of faceplate receptacles and corresponding cable connectors.

FIG. 3 is a table illustrating the interoperability among QX receptacles and cables.

FIGS. 4A-4D illustrate an example QX1 cable and an example QX1 receptacle.

FIGS. 5A-5D illustrate example QX2 cables and QX2 receptacles.

FIGS. 6A-6D illustrate an example QX4 cable and an example QX4 receptacle.

FIGS. 7A-7C illustrate top views of an example QX4 receptacle with example QX4, QX2, and QX1 cables.

FIG. 8A illustrates a front view of a QX4 receptacle and FIGS. 8B-8D illustrate cross-sectional views of a QX4 receptacle with example QX4, QX2, and QX1 cables.

FIGS. 9A-9C illustrate top views of example QX4 receptacles with example QX4 cables.

FIG. 10 is a table illustrating the interoperability among joint-type and split-type QX2 and QX4 receptacles and cables.

FIG. 11 illustrates a top view of one example of a QX4 or QX2 receptacle and a QX4 or QX2 cable.

FIG. 12 illustrates example bay and lane assignments for split-type QX receptacles and cables.

FIG. 13 illustrates example bay and lane assignments for joint-type QX receptacles and cables.

FIG. 14 illustrates example signal assignments in QX receptacle bays.

FIG. 15 is a table illustrating example signal combinations to detect cable types installed in a joint-type QX2 receptacle.

FIG. 16 is a table illustrating example signal combinations to detect cable types installed a joint-type QX4 receptacle,

FIG. 17 illustrates example joint-type QX receptacle bays with additional management signal and power contacts.

FIG. 18 illustrates one example of a system including management signals communicating across a cable.

FIG. 19 illustrates examples of QX receptacle bays and cables having contacts for management signals.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Traditional network ports have a fixed number of lanes. A lane includes a pair of transmit differential signals and a pair of receive differential signals for network communications. For example, 1 GbE and 10 GbE can be 1-lane, 10 GbE, 40 GbE, and 100 GbE may be 4-lane, and 100 GbE may be 10-lane, Accordingly, network chips, connectors, and cables have been defined to provide a fixed number of lanes for a network port. Ethernet standards have been emerging where a port of a network chip may be configured to be a 4-lane port (e.g., 4×25 G for 100 GbE), a 2-lane port (e.g., 2×25 G for 50 GbE), or a 1-lane port (e.g., 1×25 G for 25 GbE). Existing connectors and cables for network ports are defined for a fixed number of lanes. This is not a problem for 1-lane ports or for multi-lane ports as long as the application calls for fixed lane-count ports (e.g., QSFP for a 4-lane port). When a multi-lane port of a chip in a network switch system, however, needs to be connected by network interface chips in computer systems having a varying number of lanes (e.g., 1-lane, 2-lane, 4-lane), the fixed lane-count connectors and cables will force certain lanes on a network chip port to be unusable, thus resulting in wasted or stranded lanes. A network chip may be a switch ASIC, a NIC (network interface controller) chip, an electrical transceiver chip (e.g., retimer, redriver), an optical transceiver chip, or a combination of these chips interconnected.

To minimize product models, many switches include QSFP ports. Using only one lane or two lanes out of the available four lanes, however, is wasteful. Therefore, users may buy switches with QSFP 4-lane ports for future proofing, and use break-out cables to fan-out four SFP 1-lane ports or two 2-lane ports for every QSFP port or for every two QSFP ports, respectively. This approach is expensive and can introduce signal integrity and connection reliability issues. Accordingly, this disclosure describes receptacles and cable connectors to allow receptacles on the system side to accept different lane-count cables so that switch manufacturers can design one system with one set of connectors on each faceplate that will allow varying lane-count cables. Switch port signals may be connected to specific receptacle connector bays in a way that all the lanes of the network chips can be used regardless of the cable type installed. Therefore, the disclosure provides for high connector density and lower solution costs by enabling simple and compact connector designs. In addition, management signals may be provided in the connectors for dynamic detection of the cable types so that system management logic can appropriately configure the network switch chips and/or transceiver chips to support the cables installed.

Each network port connection is provided on a switch in the form of a receptacle for an external cable to be connected. Although the receptacles may be implemented on the front or the rear side of a switch, this disclosure uses the term “faceplate” to generically describe where the receptacles are located for cables to be installed.

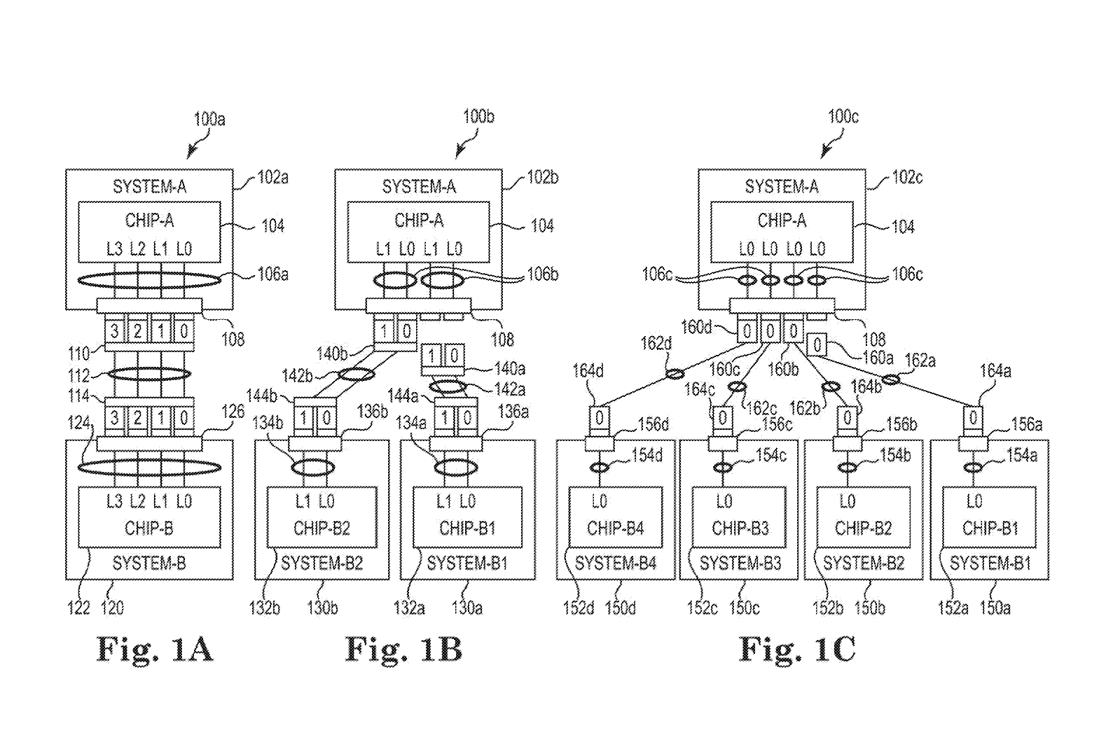

FIGS. 1A-1C illustrate examples of systems including modularly scalable connectors and cables. FIG. 1A illustrates one example of a system 100a. System 100a includes a system-A 102a and a system-B 120. System-A 102a includes a network chip-A 104 communicatively coupled to a receptacle 108 via a 4-lane port 106a. System-B 120 includes a network chip-B 122 communicatively coupled to a receptacle 126 via a 4-lane port 124. A cable 112 having a first 4-lane cable connector 110 at one end of the cable and a second 4-lane cable connector 114 at the other end of the cable communicatively couples system-A 102a to system-B 120. First 4-lane cable connector 110 is connected to receptacle 108, and second 4-lane cable connector 114 is connected to receptacle 126. In this example, both system-A 102a and system-B 120 use a 4-lane receptacle and network chip-A 104 and network chip-B 122 are configured for 4-lanes L0, L1, L2, and L3.

FIG. 1B illustrates one example of a system 100b. System 100b includes a system-A 102b, a system-B1 130a, and a system-B2 130b. System-A 102b includes a network chip-A 104 communicatively coupled to a receptacle 108 via two 2-lane ports 106b. System-B1 130a includes a network chip-B1 132a communicatively coupled to a receptacle 136a via a 2-lane port 134a. A cable 142a having a first 2-lane cable connector 140a at one end of the cable and a second 2-lane cable connector 144a at the other end of the cable may communicatively couple (shown disconnected in FIG. 1B) system-A 102b to system-B1 130a. First 2-lane cable connector 140a may be connected to receptacle 108, and second 2-lane cable connector 144a is connected to receptacle 136a.

System-B2 130b includes a network chip-B2 132b communicatively coupled to a receptacle 136b via a 2-lane port 134b. A cable 142b having a first 2-lane cable connector 140b at one end of the cable and a second 2-lane cable connector 144b at the other end of the cable communicatively couples system-A 102b to system-B2 130b. First 2-lane cable connector 140b is connected to receptacle 108, and second 2-lane cable connector 144b is connected to receptacle 136b. In this example, while system-A 102b uses a 4-lane receptacle, system-B1 130a and system-B2 130b use 2-lane receptacles. Network chip-A 104 is configured for a pair of 2-lanes L0, L1, and network chip-B1 132a and network chip-B2 132b are each configured for a corresponding 2-lanes L0, L1.

FIG. 1C illustrates one example of a system 100c. System 100c includes a system-A 102c, a system-B1 150a, a system-B2 150b, a system-B3 150c, and a system-B4 150d. System-A 102c includes a network chip-A 104 communicatively coupled to a receptacle 108 via four 1-lane ports 106c. System-B1 150a includes a network chip-B1 152a communicatively coupled to a receptacle 156a via a 1-lane port 154a. A cable 162a having a first 1-lane cable connector 160a at one end of the cable and a second 1-lane cable connector 164a at the other end of the cable may communicatively couple (shown disconnected in FIG. 1C) system-A 102c to system-B1 150a. First 1-lane cable connector 160a may be connected to receptacle 108, and second 1-lane cable connector 164a may be connected to receptacle 156a.

System-B2 150b includes a network chip-B2 152b communicatively coupled to a receptacle 156b via a 1-lane port 154b. A cable 162b having a first 1-lane cable connector 160b at one end of the cable and a second 1-lane cable connector 164b at the other end of the cable communicatively couples system-A 102c to system-B2 150b. First 1-lane cable connector 160b is connected to receptacle 108, and second 1-lane cable connector 164b is connected to receptacle 156b.

System-B3 150c includes a network chip-B3 152c communicatively coupled to a receptacle 156c via a 1-lane port 154c. A cable 162c having a first 1-lane cable connector 160c at one end of the cable and a second 1-lane cable connector 164c at the other end of the cable communicatively couples system-A 102c to system-B3 150c. First 1-lane cable connector 160c is connected to receptacle 108, and second 1-lane cable connector 164c is connected to receptacle 156c.

System-B4 150d includes a network chip-B4 152d communicatively coupled to a receptacle 156d via a 1-lane port 154d. A cable 162d having a first 1-lane cable connector 160d at one end of the cable and a second 1-lane cable connector 164d at the other end of the cable communicatively couples system-A 102c to system-B4 150d. First 1-lane cable connector 160d is connected to receptacle 108, and second 1-lane cable connector 164d is connected to receptacle 156d. In this example, while system-A 102c uses a 4-lane receptacle, system-B1 150a, system-B2 150b, system-B3 150c, and system-B4 150d each use a 1-lane receptacle. Network chip-A 104 is configured for four 1-lanes L0and network chip-B1 152a, network chip-B2 152b, network chip-B3 152c, and network chip-B4 152d are each configured for a corresponding 1-lane L0.

In systems 100a-100c, the network chip-A ports and cable signal paths are fully utilized so there are no stranded lanes. Each cable is independently connecting the corresponding ports on system-A and system-B so there is no single point-of-failure. Each cable is directly coupled between a system-A port and a system-B port such that no additional connectors or cable stages are used, thereby improving signal integrity, improving connection reliability, and reducing cost. In addition, the 4-lane system receptacle may be more compact than four independent 1-lane receptacles. System-A, which is the same in systems 100a-100c, has receptacle 108 to enable coupling to system-B1, system-B2, system-B3, and system-B4, which have network chips having different lane-counts, by using appropriate lane-count cables, thereby reducing the system-A development cost. Without receptacle 108 and configurable network chip-A 104, different system-A designs would be needed to support varying number of lane count receptacles to avoid stranded ports.

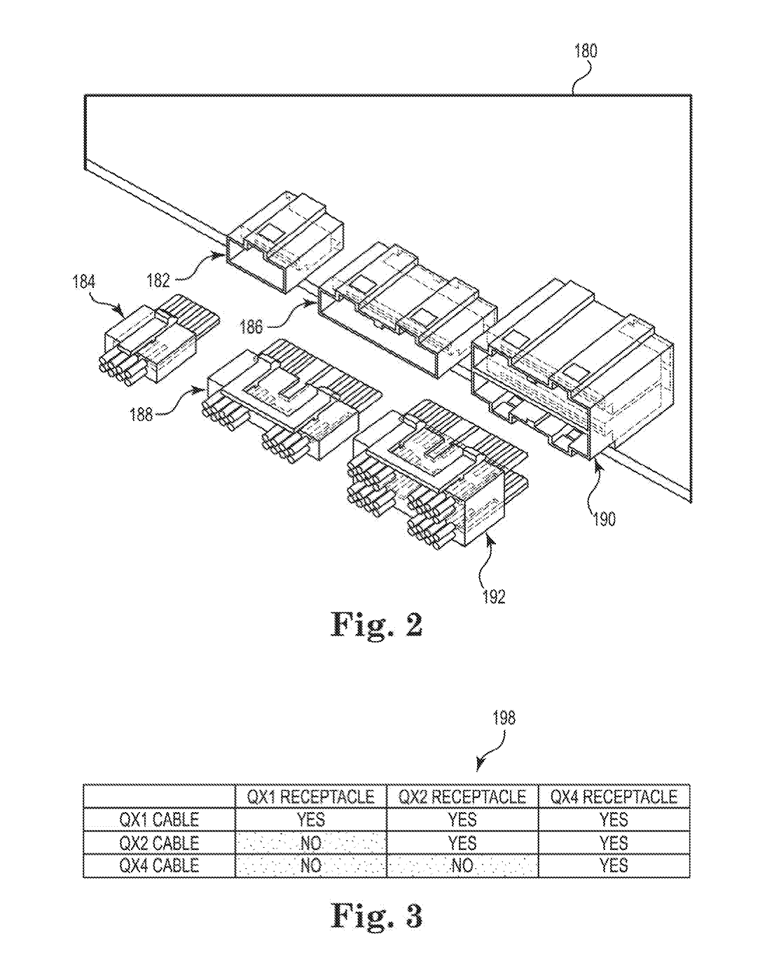

FIG. 2 illustrates examples of faceplate receptacles and corresponding cable connectors. As used herein, three receptacle types and three cable types for 1-lane, 2-lane, and 4-lane signals are defined as follows:
QX1—1-lane receptacle and 1-lane cable
QX2—2-lane receptacle and 2-lane cable
QX4—4-lane receptacle and 4-lane cable
   “QX” can be interpreted as “a quarter times (or multiply by)” where “quarter” may be further interpreted in one example as 25 Gbps of 100 Gbps (e.g., Ethernet standard), or one quarter of a 4-bay receptacle.

FIG. 2 illustrates a QX1 receptacle 182, a QX2 receptacle 186, and a QX4 receptacle 190 mounted on a printed circuit board (PCB) 180, QX1 receptacle 182 is a 1-lane receptacle for connecting to a corresponding QX1 1-lane cable 184. As used herein, the term “cable” includes the cable connector. QX2 receptacle 186 is a 2-lane receptacle for connecting to a corresponding QX2 2-lane cable 188. QX4 receptacle 190 is a 4-lane receptacle for connecting to a corresponding QX4 4-lane cable 192. The signal conductors of QX2 and QX4 cables may be combined in one cable cord (not shown).

FIG. 3 is a table 198 illustrating the interoperability among QX receptacles and cables. As illustrated in table 198, the QX2 receptacle 186 (FIG. 2) may also be connected to two QX1 cables 184, and the QX4 receptacle 190 may also be connected to two QX2 cables 188 or four QX1 cables 184. QX1 receptacle 182 and QX1 cable 184, QX2 receptacle 186 and QX2 cable 188, and QX4 receptacle 190 and QX4 cable 192 are further described below with reference to the following figures.

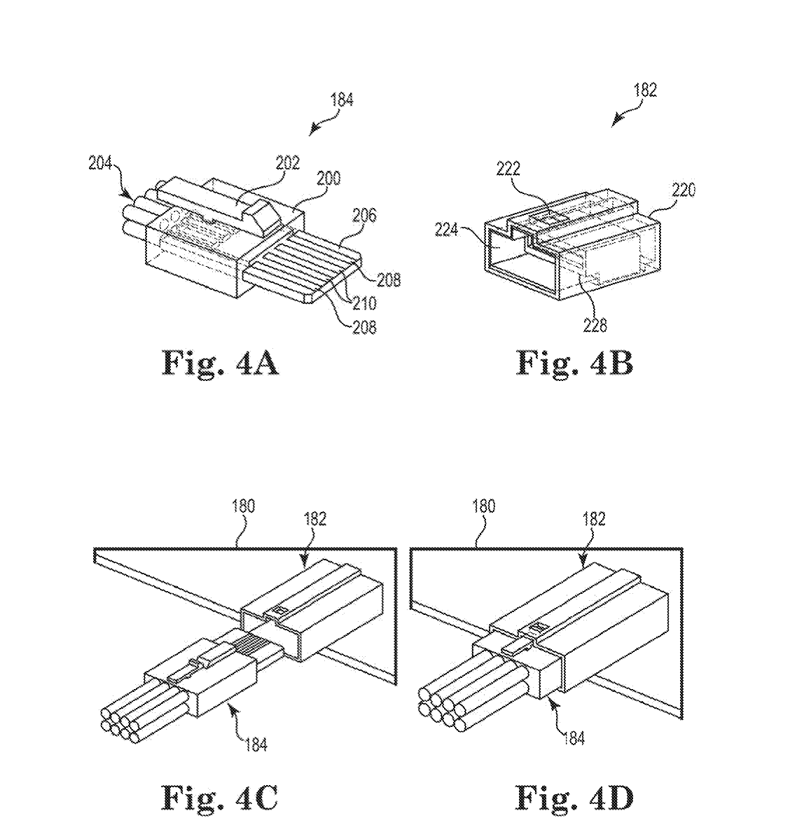

FIGS. 4A-4D illustrate an example QX1 cable 184 and an example QX1 receptacle 182. As illustrated in FIG. 4A, QX1 cable 184 includes a cable connector 200, a latch 202, cable conductors 204, and a cable connector finger 206. Cable conductors 204 are combined within a cable cord (not shown) of the QX1 cable. Latch 202 is attached to cable connector 200. Latch 202 ensures positive retention of QX1 cable 184 in QX1 receptacle 182 when the cable is installed, and allows easy removal of the cable from QX1 receptacle 182. Cable connector finger 206 is supported by cable connector 200 and includes a signal lane (i.e., 1-lane).

A signal lane includes a “transmit” differential-pair of signal pins surrounded by a pair of ground pins, and a “receive” differential-pair of signal pins surrounded by another pair of ground pins. The transmit signal pins may be arranged on one side of connector finger 206, and the receive signal pins may be arranged on the opposite side of connector finger 206. One differential-pair of signal pins 210 surrounded by a pair of ground pins 208 are visible in FIG. 4A. Additional pins (not shown) may be arranged on connector finger 206 for management signals or other suitable signals. Cable connector finger 206 may include a dielectric substrate material (e.g., FR4 PCB) and the signal pins may be gold plated contacts. The differential signal pins are electrically coupled to corresponding conductors 204 within cable connector 200. The ground pins may be combined and electrically coupled to a cable shield or corresponding ground conductors in a cable cord.

As illustrated in FIG. 4B, QX1 receptacle 182 includes a housing 220 and a receptacle connector bay 228 within the housing. Housing 220 includes a keyed bay opening 224 and a latch area 222 to ensure that a QX1 cable 184 is correctly oriented prior to installing into a QX1 receptacle as illustrated in FIG. 4C. Once installed in a QX1 receptacle 182 as illustrated in FIG. 4D, the connector finger 206 of QX1 cable 184 is within receptacle connector bay 228 such that the signal pins are electrically connected to corresponding signal lines of PCB 180 via contacts within QX1 receptacle 182.

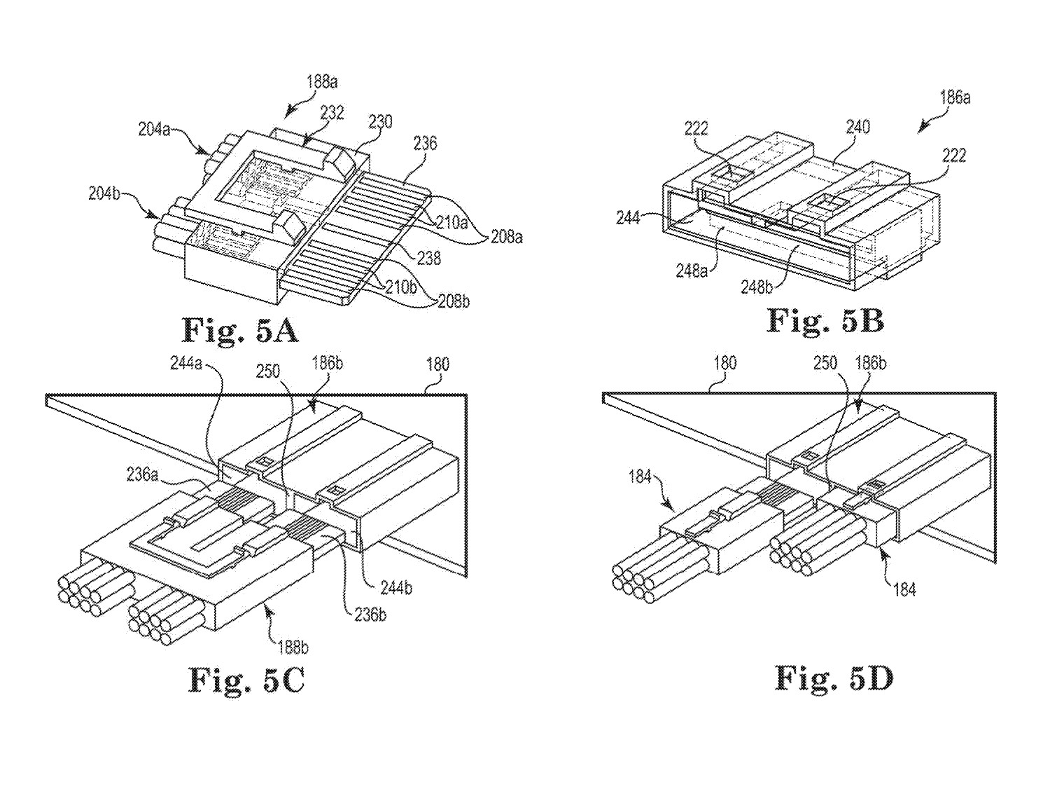

FIGS. 5A-5D illustrate example QX2 cables and QX2 receptacles. As illustrated in FIG. 5A, QX2 cable 188a includes a cable connector 230, a latch 232, cable conductors 204a and 204b, and a cable connector finger 236. Cable conductors 204a and 204b are combined within a cable cord (not shown) of the QX2 cable. Latch 232 is attached to cable connector 230 and includes two levers that are linked to each other such that one motion will actuate both levers. Latch 232 ensures positive retention of QX2 cable 188a in QX2 receptacle 186a when the cable is installed, and allows easy removal of the cable from QX2 receptacle 186a. Cable connector finger 236 is supported by cable connector 230 and includes two signal lanes (i.e., 2-lane). Two differential-pairs of signal pins 210a and 210b surrounded by a pair of ground pins 208a and 208b, respectively, are visible in FIG. 5A. Additional pins (e.g. pin 238) may be arranged on connector finger 236 in the joint area for management signals or for other suitable signals.

A QX2 cable connector may have one “joint” finger, as illustrated in FIG. 5A, or two “split” fingers, as illustrated in FIG. 5C. FIG. 5C illustrates an example of a QX2 cable 188b having split fingers 236a and 236b. A QX2 receptacle may support one QX2 cable or two QX1 cables. A QX2 receptacle may not have a divider wall, as illustrated by QX2 receptacle 186a in FIG. 5B, allowing either a joint-type QX2 cable or a split-type QX2 cable to be installed. Alternatively, a QX2 receptacle may have a divider wall 250, as illustrated by QX2 receptacle 186b in FIG. 5C, allowing a split-type QX2 cable to be installed, but not allowing a joint-type QX2 cable to be installed.

FIG. 5B illustrates an example QX2 receptacle 186a without a divider wall. QX2 receptacle 186a includes a housing 240 and two receptacle connector bays 248a and 248b within the housing. In this example, the two receptacle connector bays 248a and 248b are connected such that joint connector finger 236 (FIG. 5A) or split connector fingers 236a and 236b (FIG. 5C) may be inserted into the connector bays. In another example illustrated by QX2 receptacle 186b in FIG. 5C, a divider wall 250 divides the two receptacle connector bays 248a and 248b such that split connector fingers 236a and 236b may be inserted into the connector bays, respectively, but a joint connector finger 236 may not be inserted into the connector bays. Housing 240 includes a keyed bay opening 241 and latch areas 222 to ensure that a QX2 cable 188 is correctly oriented prior to installing into a QX2 receptacle as illustrated in FIG. 5C.

FIG. 5D illustrates one example of connecting two QX1 cables 184 to QX2 receptacle 186b. Once installed in a QX2 receptacle as illustrated in FIG. 5D, the connector finger of each of the QX cables is within the respective receptacle connector bay 248a and 248b such that the signal pins are electrically connected to corresponding signal lines of PCB 180 via contacts within QX2 receptacle 186b. The divider wall 250 may provide EMI shielding when only one QX1 cable 184 is installed in a QX2 receptacle 186b.

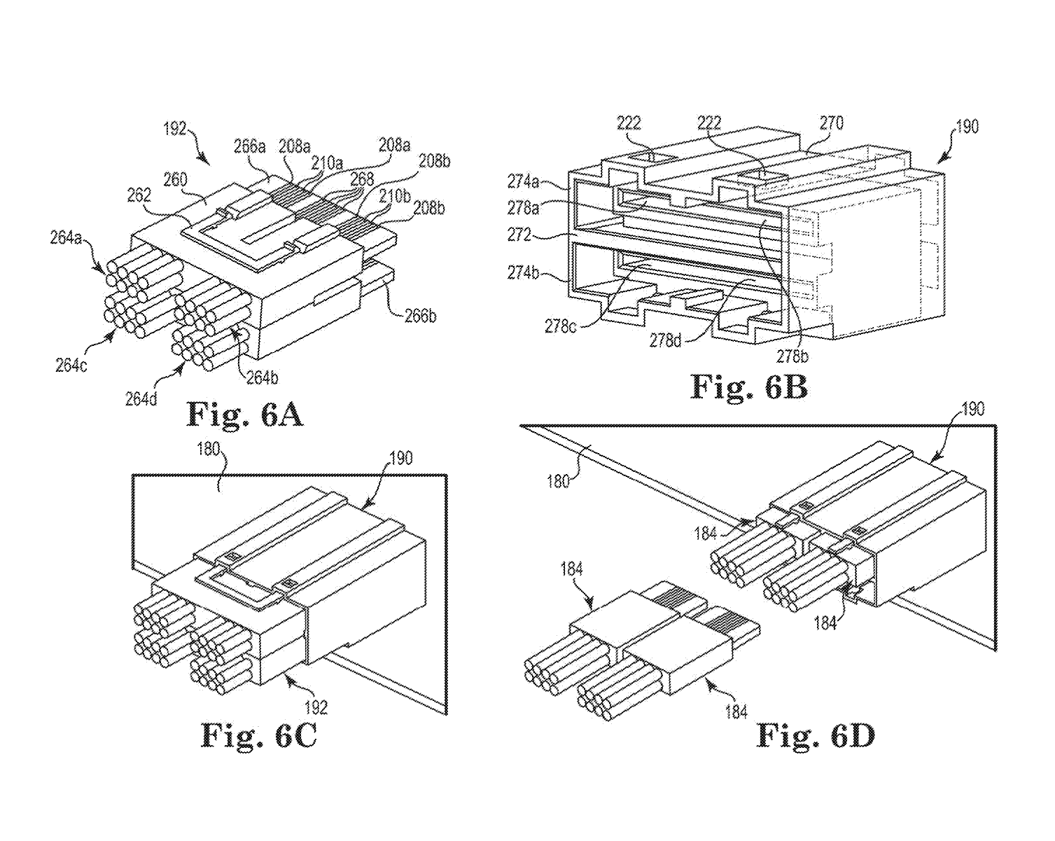

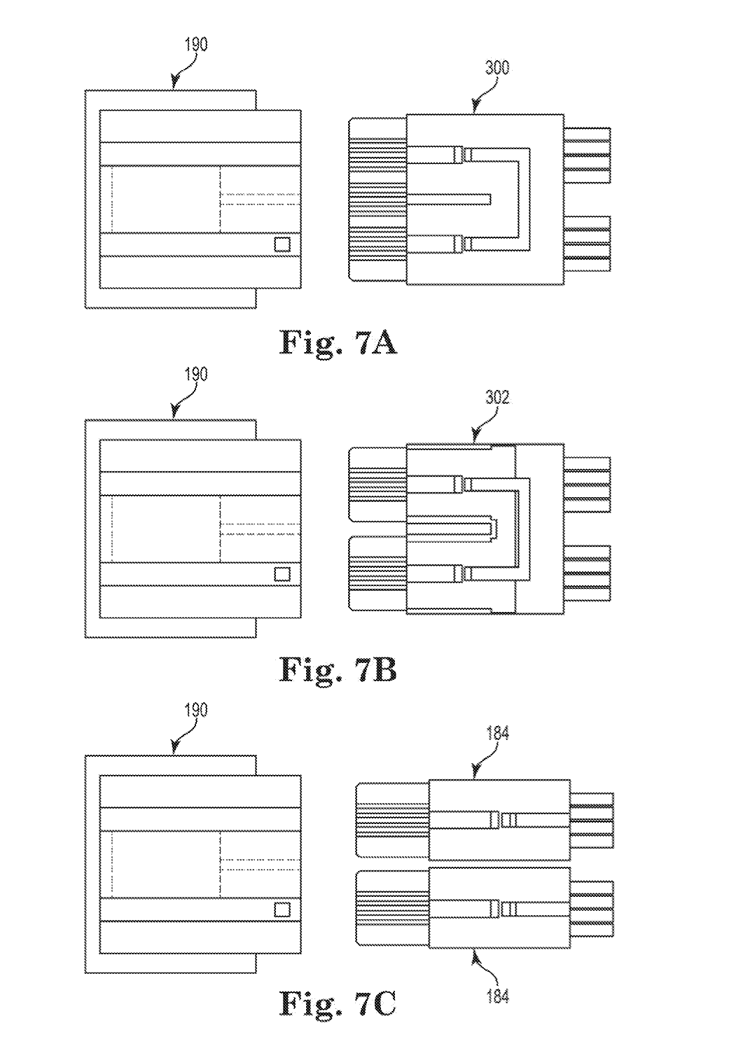

FIGS. 6A-6D illustrate an example QX4 cable and an example QX4 receptacle. As illustrated in FIG. 6A, QX4 cable 192 includes a cable connector 260, a latch 262, cable conductors 264a-264d, and joint cable connector fingers 266a and 266b. In other examples, cable connector fingers 266a and 266b may include split connector fingers as previously described and illustrated with reference to FIG. 5C. Cable conductors 264a-264d may be combined within a cable cord (not shown) of the QX4 cable.

Latch 262 is attached to cable connector 260 and includes two levers that are linked such that one motion will actuate both levers. In another example, a second latch may be arranged on the opposite side of housing 260 of cable connector 260. Latch 262 ensures positive retention of QX4 cable 192 in QX4 receptacle 190 when the cable is installed, and allows easy removal of the cable from QX4 receptacle 190. Cable connector fingers 266a and 266b are supported by cable connector 260 and include four signal lanes (i.e., 4-lane). Two differential-pairs of signal pins 210a and 210b surrounded by a pair of ground pins 208a and 208b, respectively, are visible in FIG. 6A. Additional pins (e.g. pins 268) may be arranged on connector fingers 266a and/or 266b in the joint area for management signals or for other suitable signals. The ground pins may be longer than the differential signal and additional pins.

FIG. 6B illustrates an example QX4 receptacle 190. A QX4 receptacle may support one QX4 cable, two QX2 cables, or four QX1 cables. QX4 receptacle 190 includes a housing 270 and four receptacle connector bays 278a-278d within the housing. In this example, receptacle connector bays 278a and 278b are connected such that a joint connector finger 266a or split connector fingers may be inserted into the connector bays. Receptacle connector bays 278c and 278d are also connected such that a joint connector finger 266b or split connector fingers may be inserted into the connector bays. In another example, a divider wall divides receptacle connector bays 278a and 278b and receptacle connector bays 278c and 278d such that split connector fingers may be inserted into the connector bays, but joint connector fingers may not be inserted into the connector bays.

Housing 270 includes keyed bay openings 274a and 278b separated by a divider 272. Housing 270 also includes latch areas 222 to ensure that a QX4 cable 192, QX2 cable 188, or a QX1 cable 184 is correctly oriented prior to installing into a QX4 receptacle as illustrated in FIGS. 6C and 6D. Two latch areas 222 (Le., one for bay 278a and one for bay 278b) are shown in FIG. 6B, however, two additional latch areas 222 are arranged on the opposite side of housing 270 (Le., one for bay 278c and one for bay 278d). Accordingly, a QX1 or QX2 cable inserted into a lower receptacle connector bay 278c and/or 278d is flipped 180 degrees with respect to a QX1 or QX2 cable inserted into an upper receptacle connector bay 278a and/or 278b.

FIG. 6D illustrates one example of connecting four QX1 cables 184 to QX4 receptacle 190. Once installed in a QX4 receptacle as illustrated in FIG. 6D, the connector finger of each of the QX1 cables is within the respective receptacle connector bay 278a-278d such that the signal pins are electrically connected to corresponding signal lines of PCB 180 via contacts of QX4 receptacle 190. While FIGS. 6A-6D illustrate 4-lane cables and 4-lane receptacles having a 2×2 configuration, in other examples, the 4-lane cables and 4-lane receptacles may have a 1×4 configuration (i.e., arranged in one plane).

FIGS. 7A-7C illustrate top views of an example QX4 receptacle 190 with example QX4, QX2, and QX1 cables. FIG. 7A illustrates a joint finger QX cable 300 useable with QX4 receptacle 190. Joint finger QX cable 300 may be a QX2 cable 188a (FIG. 5A) or a QX4 cable 192 (FIG. 6A). FIG. 7B illustrates a split finger QX cable 302 useable with QX4 receptacle 190. Split finger QX cable 302 may be a QX2 cable 188b (FIG. 5C) or a split finger QX4 cable. FIG. 7C illustrates QX1 cables 184 useable with QX4 receptacle 190. Therefore, the same QX4 receptacle may be used with a QX4 cable, two QX2 cables, or four QX1 cables.

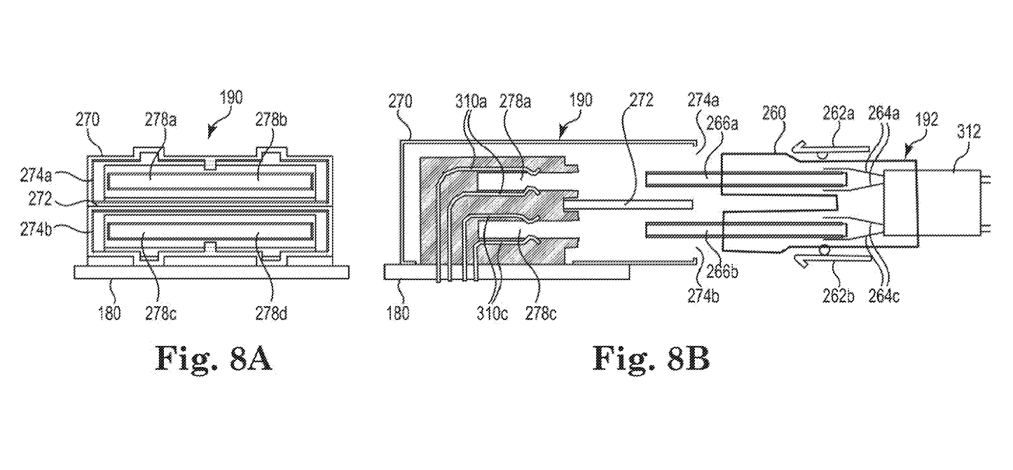

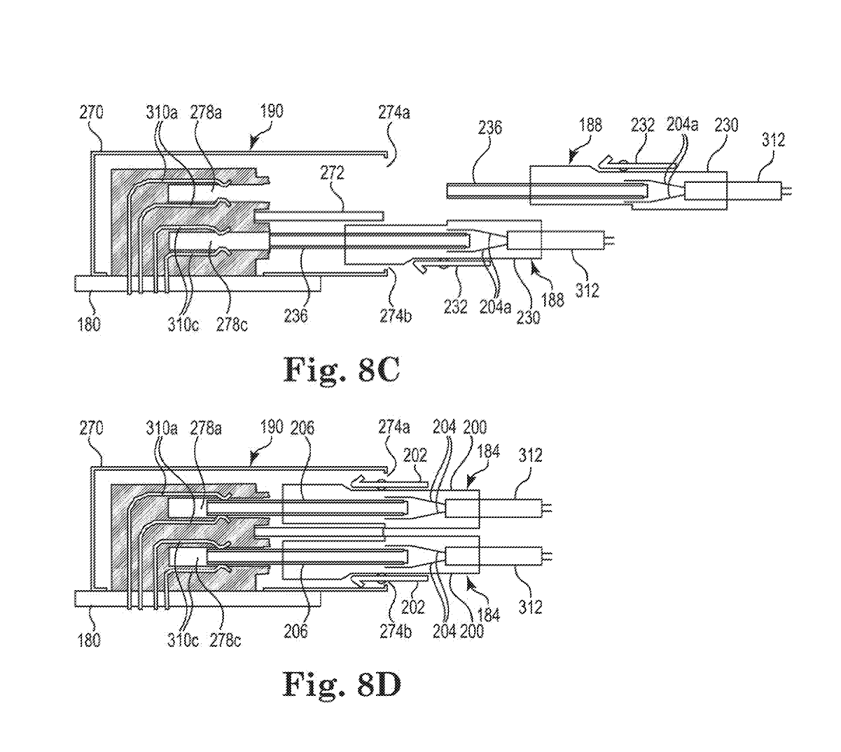

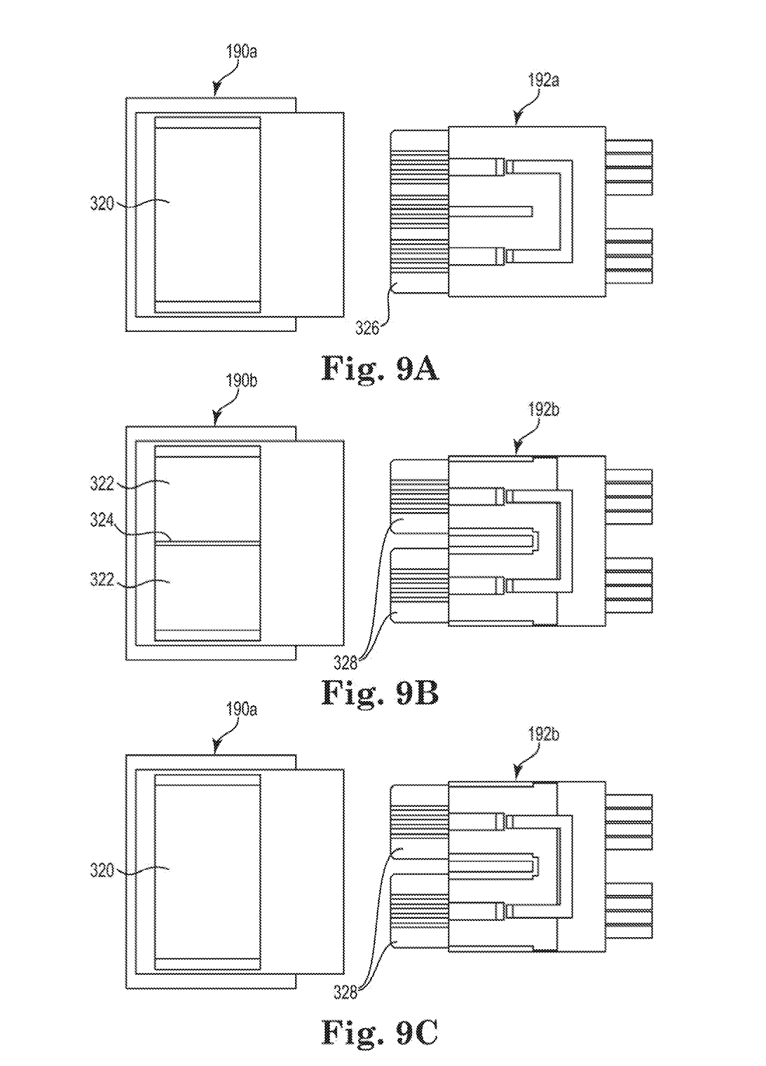

FIG. 8A illustrates a front view of QX4 receptacle 190 and FIGS. 8B-8D illustrate cross-sectional views of QX4 receptacle 190 with example QX4, QX2, and QX1 cables. As previously described with reference to FIG. 6B, QX4 receptacle 190 in FIG. 8A includes receptacle connector bays 278a and 278b in the upper joint bay and receptacle connector bays 278c and 278d in the lower joint bay.

FIG. 8B illustrates a cross-sectional view of one example of a QX4 cable 192 being inserted into QX4 receptacle 190. QX4 receptacle 190 includes contacts 310a in receptacle bay 278a and contacts 310c in receptacle bay 2′78c. Contacts 310a contact signal pins on connector finger 266a and contacts 310c contact signal pins on connector finger 266b when QX4 cable 192 is installed in QX4 receptacle 190. Contacts 310a and 310c are electrically coupled to corresponding signal lines in PCB 180. The signal pins on connector finger 266a are electrically coupled to signal conductors 264a. The signal pins on connector finger 266b are electrically coupled to signal conductors 264c. The signal conductors 264a and 264c are bundled into a cable cord 312. In this example, QX4 cable 192 includes a latch 262a on the upper side of housing 260 and a latch 262b on the lower side of housing 260. In other examples, QX4 cable 192 includes one latch 262a or 262b and excludes the other.

FIG. 8C illustrates a cross-sectional view of one example of two QX2 cables 188 being inserted into QX4 receptacle 190. Contacts 310a of QX4 receptacle 190 contact signal pins on connector finger 236 of a first QX2 cable 188 and contacts 310c contact signal pins on connector finger 236 of a second QX2 cable when QX2 cables 188 are installed in QX4 receptacle 190. The signal pins on each connector finger 236 are electrically coupled to signal conductors 204a. The signal conductors 204a of each cable are bundled into a cable cord 312. The second QX2 cable is flipped 180 degrees with respect to the first QX2 cable so that the latch 232 of the second QX2 cable is opposite to the latch 232 of the first QX2 cable.

FIG. 8D illustrates a cross-sectional view of one example of two QX1 cables 184 inserted in QX4 receptacle 190. Contacts 310a of QX4 receptacle 190 contact signal pins on connector finger 206 of a first QX1 cable 184 and contacts 310c contact signal pins on connector finger 206 of a second QX1 cable when the QX1 cables are installed in QX4 receptacle 190. The signal pins on each connector finger 206 are electrically coupled to signal conductors 204. The signal conductors 204 of each cable are bundled into a cable cord 312. The second QX1 cable is flipped 180 degrees with respect to the first QX1 cable so that the latch 202 of the second QX1 cable is opposite to the latch 202 of the first QX1 cable.

FIGS. 9A-9C illustrate top views of example QX4 receptacles with example QX4 cables. FIG. 9A illustrates one example of a QX4 receptacle 190a having joint bays 320. A joint bay 320 includes two receptacle bays 278a and 278b or 278c and 278d as previously described and illustrated with reference to FIG. 6B. As used herein, a QX receptacle having joint bays is referred to as a QXj receptacle (i.e., QX4j receptacle or QX2j receptacle). The joint bays 320 are useable with joint fingers 326 of a QX4 cable 192a. As used herein, a QX cable have a joint finger is referred to as a QXj cable (i.e., QX4j cable or QX2j cable).

FIG. 98 illustrates one example of a QX4 receptacle 190b having split bays 322. As used herein, a QX receptacle having split bays is referred to as a QXs receptacle (i.e., QX4s receptacle or QX2s receptacle). Split bays 322 are divided by a wall 324. The split bays 322 are useable with split fingers 328 of a QX4 cable 192b. As used herein, a QX cable have split fingers is referred to as a QXs cable (i.e., QX4s cable or QX2s cable). FIG. 9C illustrates one example of a QX4j receptacle 190a with a QX4s cable 192b.

FIG. 10 is a table 340 illustrating the interoperability among joint-type and split-type QX2 and QX4 receptacles and cables. As shown in table 340, a QX1 cable can be used with a QX1, QX2j, QX2s, QX4j, or QX4s receptacle. A QX2j cable can be used with a QX2j or QX4j receptacle. A QX2s cable can be used with a QX2j, QX2s, QX4j, or QX4s receptacle, A QX4j cable can be used with a QX4j receptacle, and a QX4s cable can be used with a QX4j or QX4s receptacle.

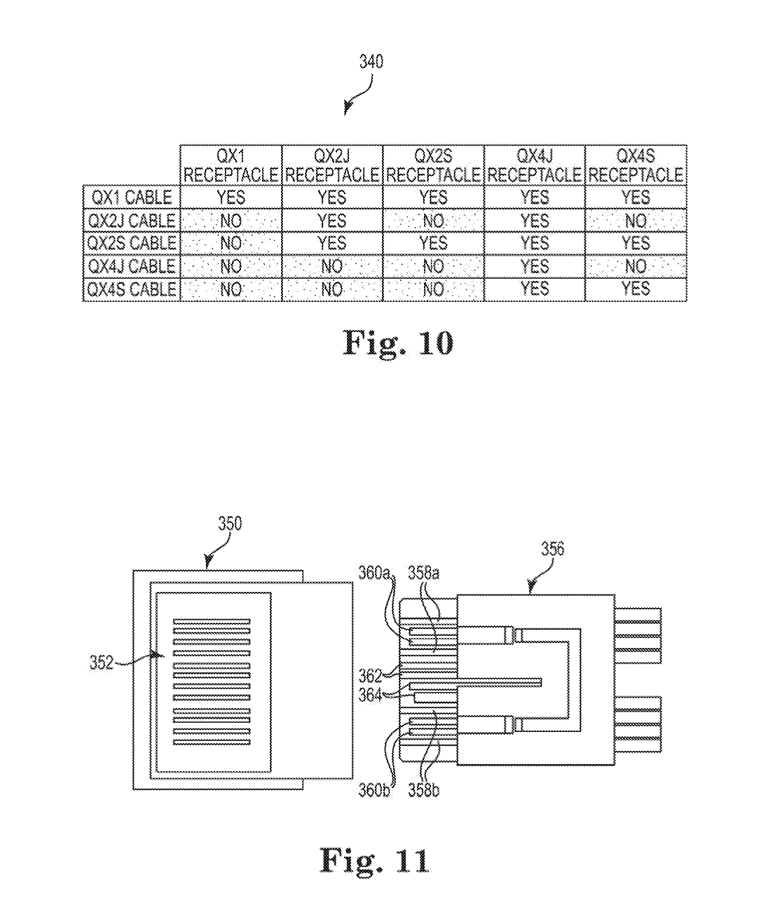

FIG. 11 illustrates a top view of one example of a QX4 or QX2 receptacle 350 and a QX4 or QX2 cable 356. QX4 or QX2 receptacle 350 includes receptacle connector contacts 352. QX4 or QX2 cable 356 includes ground pins 358a and 358b, differential signal pins 360a and 360b, management signal pins 362, and power pins 364. Each receptacle connector contact 352 corresponds to one of ground pins 358a and 358b, differential signal pins 360a and 360b, management signal pins 362, and power pins 364. Receptacle connector contacts 352 electrically couple each of the ground pins 358a and 358b, differential signal pins 360a and 360b, management signal pins 362, and power pins 364 to corresponding ground, signal lines, and power of a PCB. The pin lengths may be the same or different. For example, ground pins 358a and 358b and management pins 362 may be longer than differential signal pins 360a and 360b and power pins 364.

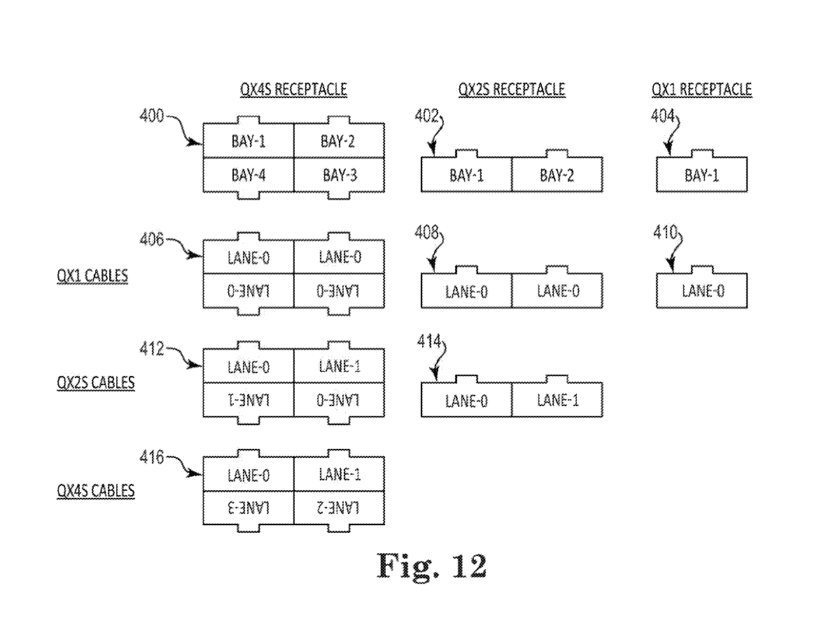

FIG. 12 illustrates one example of bay and lane assignments for QX split-type receptacles and cables. A QX4s receptacle as indicated at 400 has four split bays including bay-1 in the upper left, bay-2 in the upper right, bay-3 in the lower right, and bay-4 in the lower left. When using QX1 cables with a QX4s receptacle as indicated at 406, each of the four bays are assigned lane-0 such that a network chip is configured for up to four 1-lane ports. When using QX2s cables with a QX4s receptacle as indicated at 412, bay-1 and bay-2 are assigned lane-0 and lane-1, respectively, and bay-3 and bay-4 are assigned lane-0 and lane-1, respectively, such that a network chip is configured for up to two 2-lane ports. When using a QX4s cable with a QX4s receptacle as indicated at 416, bay-1 is assigned lane-0, bay-2 is assigned lane-1, bay-3 is assigned lane-2, and bay-4 is assigned lane-3 such that a network chip is configured for one 4-lane port.

A QX2s receptacle as indicated at 402 has two split bays including bay-1 in the left and bay-2 in the right. When using QX1 cables with a QX2s receptacle as indicated at 408, each of the two bays are assigned lane-0 such that a network chip is configured for up to two 1-lane ports. When using QX2s cables with a QX2s receptacle as indicated at 414, bay-1 is assigned lane-0 and bay-2 is assigned lane-1 such that a network chip is configured for one 2-lane port. A QX1 receptacle as indicated at 404 has one bay (Le., bay-1), which is assigned lane-0 as indicated at 410 for use with a QX1 cable such that a network chip is configured for one 1-lane port.

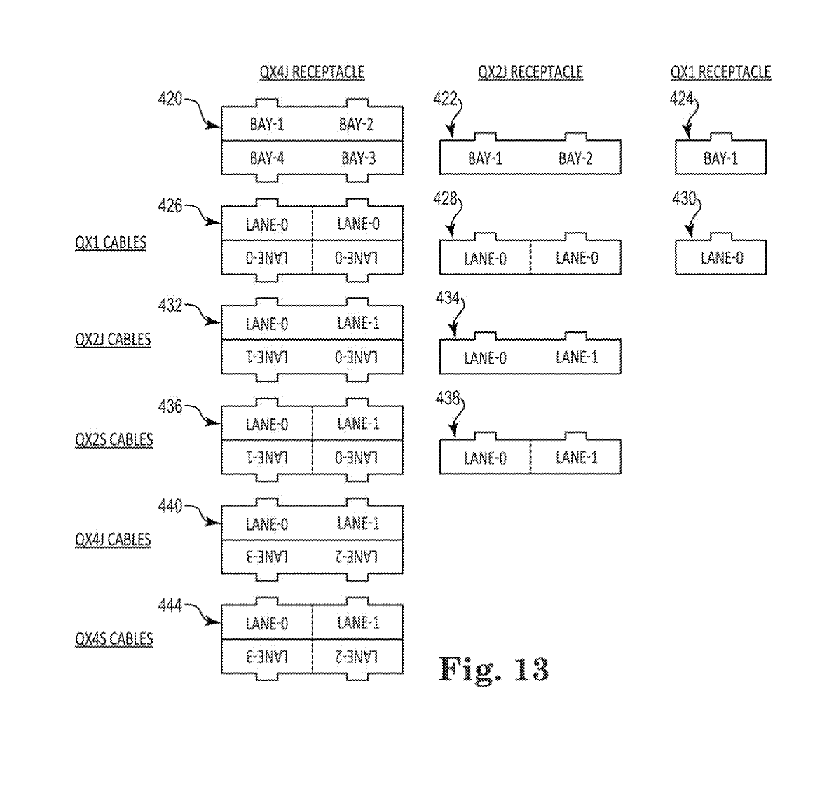

FIG. 13 illustrates example bay and lane assignments for QX joint-type receptacles and cables. A QX4j receptacle as indicated at 420 has two joint bays providing four total bays including bay-1 in the upper left, bay-2 in the upper right, bay-3 in the lower right, and bay-4 in the lower left, Bay-1 and bay-2 provide a first joint bay, and bay-3 and bay-4 provide a second joint bay. When using QX1 cables with a QX4j receptacle as indicated at 426, each of the four bays are assigned lane-0 such that a network chip is configured for up to four 1-lane ports. When using QX2j or QX2s cables with a QX4j receptacle as indicated at 432 and 436, respectively, bay-1 and bay-2 are assigned lane-0 and lane-1, respectively, and bay-3 and bay-4 are assigned lane-0 and lane-1, respectively, such that a network chip is configured for up to two 2-lane ports. When using a QX4j cable or QX4s cable with a QX4j receptacle as indicated at 440 and 444, respectively, bay-1 is assigned lane-0, bay-2 is assigned lane-1, bay-3 is assigned lane-2, and bay-4 is assigned lane-3 such that a network chip is configured for one 4-lane port.

A QX2j receptacle as indicated at 422 has one joint bay providing two total bays including bay-1 in the left and bay-2 in the right. When using QX1 cables with a QX2j receptacle as indicated at 428, each of the two bays are assigned lane-0 such that a network chip is configured for up to two 1-lane ports. When using QX2j or QX2s cables with a QX2j receptacle as indicated at 434 and 438, respectively, bay-1 is assigned lane-0 and bay-2 is assigned lane-1 such that a network chip is configured for one 2-lane port. A QX1 receptacle as indicated at 424 has one bay (i.e., bay-1), which is assigned lane-0 as indicated at 430 for use with a QX1 cable such that a network chip is configured for one 1-lane port.

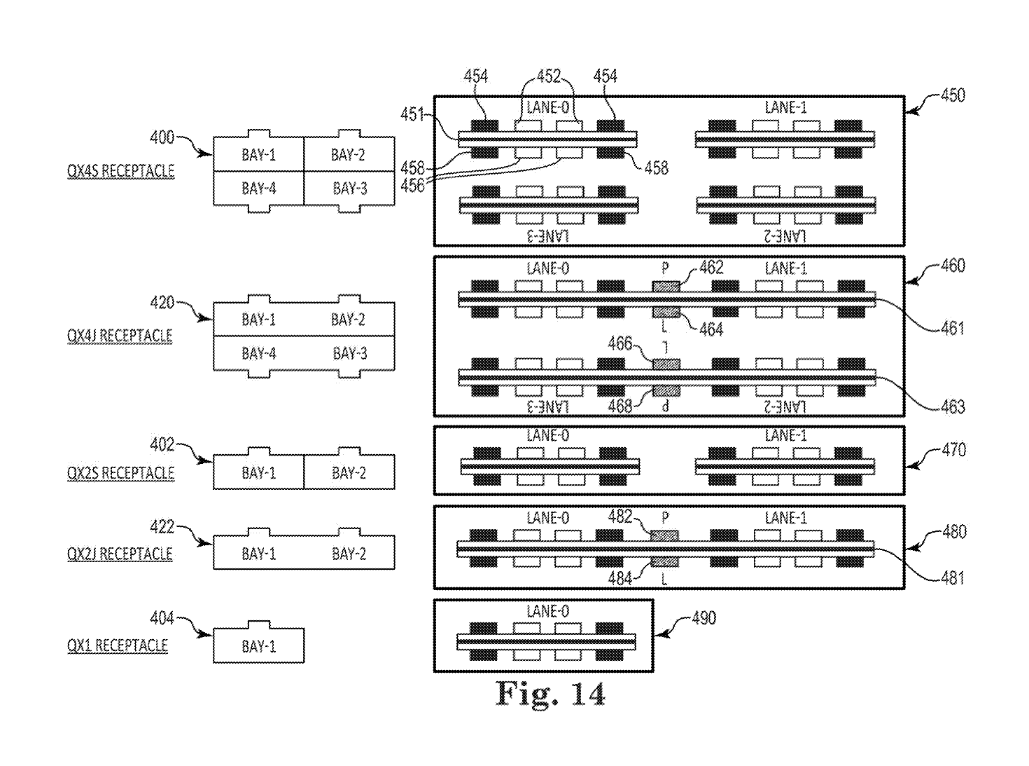

FIG. 14 illustrates example signal assignments in QX receptacle bays and cables. A QX4s cable as indicated at 450 is usable with QX4s receptacle 400. A QX4j cable as indicated at 460 is usable with QX4j receptacle 420. A QX2s cable as indicated at 470 is usable with QX2s receptacle 402. A QX2j cable as indicated at 480 is usable with QX2j receptacle 422. A QX1 cable as indicated at 490 is usable with QX1 receptacle 404. The lane assignments for each cable 450, 460, 470, and 480 correspond to the lane assignments previously described and illustrated with reference to FIGS. 12 and 13.

Each connector finger (whether a split finger as indicated at 450 or part of a joint finger as indicated at 460) includes two pairs of differential signal lines, one pair for transmit signals and another pair for receive signals. For example, a first side of connector finger 451 of QX4s cable 450 includes first differential signal pins 452 surrounded by ground pins 454, and a second side of connector finger 451 opposite to the first side includes second differential signal pins 456 surrounded by ground pins 458.

The QX4j and QX2j cables indicated at 460 and 480, respectively, may include a Presence (P) signal pin to provide a P signal to signify that an adjacent lane is present, and a Low (L) signal pin to provide an L signal to signify that the row contains the lane-0. These P and L signals are detected by a system manager when a cable is installed in a receptacle. Based on these signals, the system manager configures the network chip to provide a 1-lane, 2-lane, or 4-lane port corresponding to the installed cable. In one example, the P and L signal pins interface with corresponding receptacle contacts such that no cable conductors are used to communicate these signals across a cable.

QX4j cable 460 includes a P signal pin and an L signal pin on each joint connector finger 461 and 463. The upper connector finger 461 includes a P signal pin 462 on one side of the connector finger in the joint region and an L signal pin 464 on the opposite side of the connector finger in the joint region. The lower connector finger 463 includes an L signal pin 466 on one side of the connector finger in the joint region and a P signal pin 468 on the opposite side of the connector finger in the joint region. QX2j cable 480 includes a P signal pin 482 on one side of connector finger 481 in the joint region and an L signal pin 484 on the opposite side of connector finger 481 in the joint region.

The split-type receptacles 400 and 402 and cables 450 and 470 do not have P and L signal contacts and corresponding P and L signal pins in this example, respectively. Therefore, to dynamically detect whether a wider than one lane port is supported by an installed cable, in one example the network chips go through an auto negotiation phase to determine the lane width of the installed cable.

For a QX2j receptacle, when two QX1 cables are installed, there are no P or L signal connections. In one example, when a QX2s cable is installed, there are also no P or L signal connections. Within a QX2j cable, however, both the P and the L signal pins are connected to ground (e.g., to a ground pin or a ground plane). When a QX2j cable is installed, the system manager can detect a 2-lane cable and send appropriate messages to configure the network chip for lane-0 and lane-1, for the QX2j receptacle.

For a QX4j receptacle, when four QX1 cables are installed there are no P or L signal connections. In one example, when two QX2s or one QX4s cable is installed, there are also no P or L signal connections. When a QX2j cable is installed in the top or the bottom joint bay, the system manager can detect a 2-lane cable and send appropriate messages to configure the network chip for lane-0 and lane-1, for the QX4j receptacle top or bottom joint bay, respectively. When two QX2j cables are installed in the QX4j receptacle, the system manager can detect two 2-lane cables are installed by sensing that both P and L signals for both joint bays are connected to ground. As previously described, there are ground pins on each cable connector finger surrounding the differential signal pins. The P and/or L pins may be coupled to these ground pins. Within a QX4j cable, both the P and the L signals in the top joint bay are connected to ground, but only the P signal in the bottom bay is connected to ground. When a QX4j cable is installed, the system manager can detect a 4-lane cable by sensing that both P signals and one L signal are connected to ground, and subsequently send appropriate messages to configure the network chip for lane-0, lane-1, lane-2, and lane-3 for the QX4j receptacle.

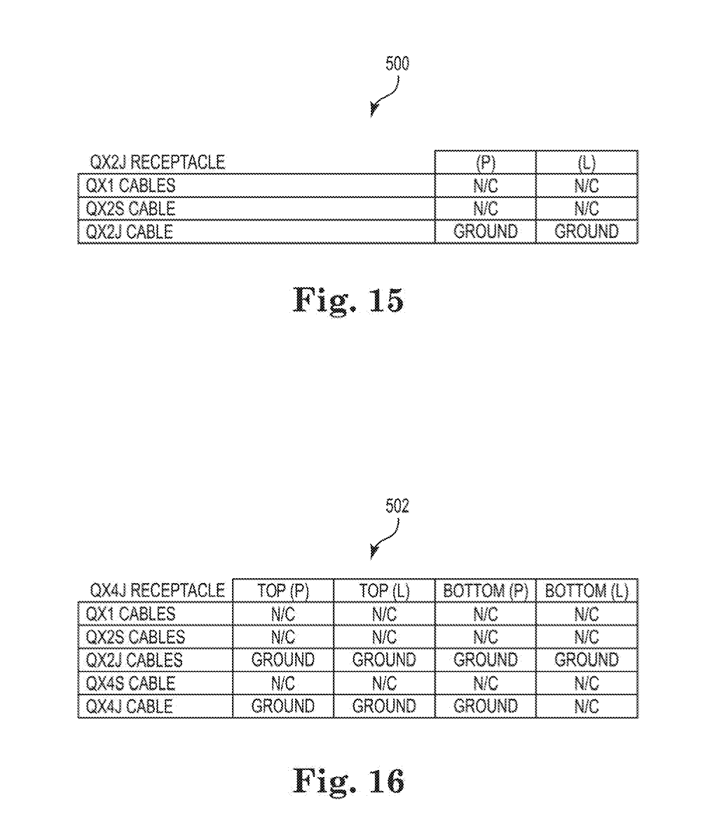

FIG. 15 is a table 500 illustrating the signal combinations to detect cable types installed in a QX2j receptacle. As indicated in table 500, the P and L signals for QX1 cables and QX2s cables installed in a QX2j receptacle are not connected to ground since the P and L signal pins may not exist for QX1 and Qx2s cables. The P and L signals for a QX2j cable installed in a QX2j receptacle are both connected to ground. Therefore, the system manager recognizes that a QX2j cable is installed and sends appropriate messages to configure the network chip for a 2-lane port.

FIG. 16 is a table 502 illustrating the signal combinations to detect cable types in a QX4j receptacle. As indicated in table 502, the top and bottom P and L signals for QX1 cables, QX2s cables, and QX4s cables installed in a QX4j receptacle are not connected to ground since the P and L signal pins may not exist for QX1, QX2s, and QX4s cables. The P and L signals for each of two QX2j cables installed in the top and bottom joint bays, respectively, of a QX4j receptacle are each connected to ground. Therefore, the system manager recognizes that two QX2j cables are installed and sends appropriate messages to configure the network chip for two 2-lane ports. The top P and L signals and the bottom P signal are connected to ground and the bottom L signal is not connected to ground for a QX4j cable installed in a QX4j receptacle. Therefore, the system recognizes that a QX4j cable is installed and sends appropriate messages to configure the network chip for a 4-lane port.

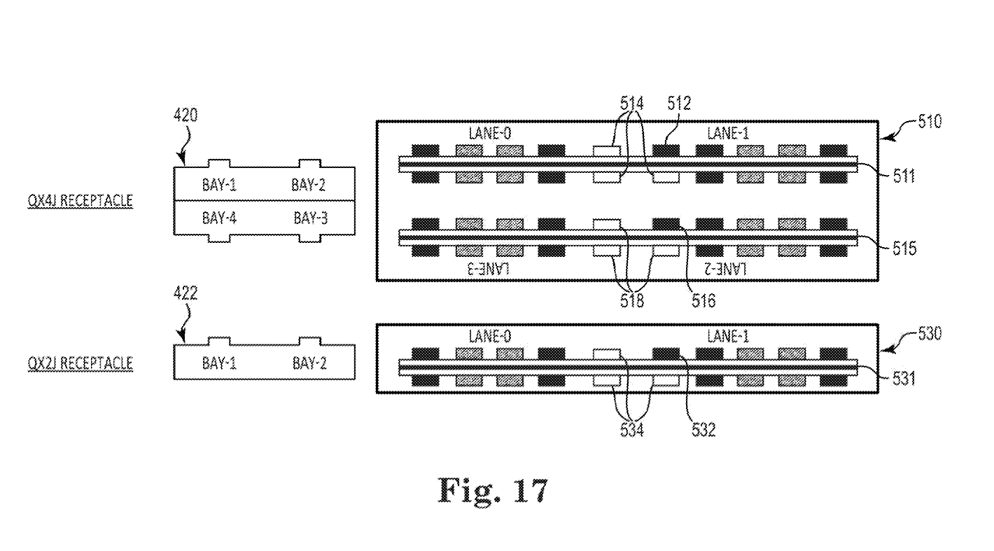

FIG. 17 illustrates example QXj receptacle bays with additional management signal and power contacts. A QX4j cable 510 useable with a QX4j receptacle 420 includes a power pin 512 and a management signal pin 514 on one side of upper connector finger 511 and management signal pins 514 on the opposite side of upper connector finger 511. The QX4j cable 510 also includes a power pin 516 and a management signal pin 518 on one side of lower connector finger 515 and management signal pins 518 on the opposite side of lower connector finger 515. A QX2j cable 530 useable with a QX2j receptacle 422 includes a power pin 532 and a management signal pin 534 on one side of the connector finger 531 and management signal pins 534 on the opposite side of connector finger 531. In one example, the management signal and power pins can be used to support on-cable tag chips (e.g., EEPROM, RFID) or for other suitable purposes. In other examples, different numbers of management pins and/or power pins may be used on either side of the connector fingers, such as to support signal repeaters within a cable connector.

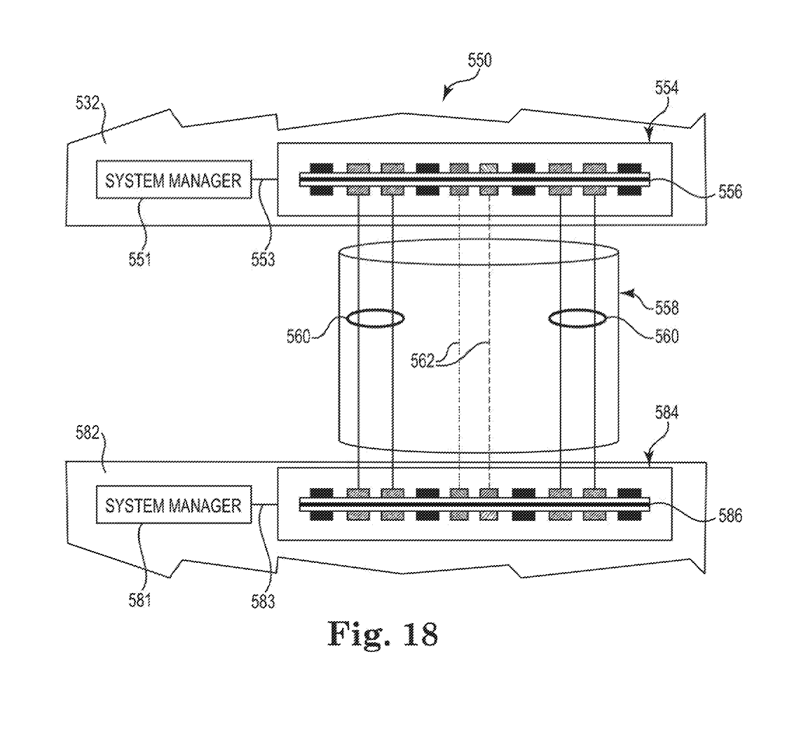

FIG. 18 illustrates one example of a system 550 including management signals communicating across a cable. System 550 includes a first system 552 and a second system 582 First system 552 includes a system manager 551 and a QX2 receptacle 554. System manager 551 is communicatively coupled to QX2 receptacle 554 via a communication link 553. Second system 582 includes a system manager 581 and a QX2 receptacle 584. System manager 581 is communicatively coupled to QX2 receptacle 584 via a communication link 583, First system 552 is communicatively coupled to second system 582 via a QX2 cable 558. In addition to the differential signal lanes 560 for a network port, management signals 562 are transported along the cable so that system manager 551 in first system 552 and system manager 581 in second system 582 can communicate with each other independently of the signal transmission on the differential signal lanes 560. The actual number of additional contacts in the receptacles and corresponding pins on the connector fingers and the number of cable conductors within a cable for the management signals may vary depending on the implementation.

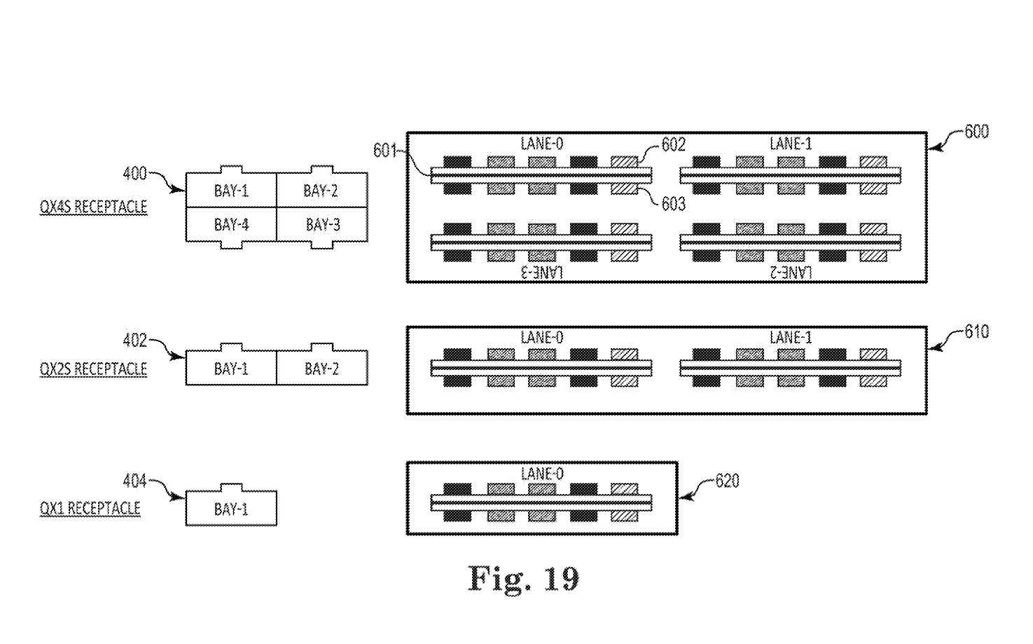

FIG. 19 illustrates examples of QX receptacle bays and cables having contacts for management signals. In one example, the management signals are P and L signals. P and L signals or similar management type signals can be added to each bay so that even the 1-lane and the split-type cables can be auto-detected. The connector finger and the cable size, however, may be larger to accommodate the management signals for each lane, and when multiple lanes are used many of the management signals may not be used.

A QX4s cable 600 useable with QX4s receptacle 400, a QX2s cable 610 useable with a QX2s receptacle 401, and a QX1 cable usable with a QX1 receptacle 404 each include bays having management signal contacts. For example, connector finger 601 of QX4s cable 600 corresponding to bay-1 of QX4s receptacle 400 includes a management pin 602 on one side of the connector finger 601 and a management pin 603 on the opposite side of connector finger 601. Similarly, the contact assignment for the management pins is replicated in each bay of each QX4 receptacle 400, QX2 receptacle 402, and QX1 receptacle 404 and corresponding QX4 cable 600, QX2 cable 610, and QX1 cable 620. Since each bay has its own set of management signals, there is no joint area needed to provide the management signals. Although the connector width may be larger for this example, it might be acceptable for applications that desire QX1 to have management signals. Some of these management signals may be connected to cable conductors so that the system manager on one end of the cable can detect the presence of a system on the other end, or the two system managers across the cable can communicate with each other.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a receptacle comprising a plurality of bays, each bay supporting 1-lane for differential transmit signals and differential receive signals,
wherein the receptacle is to connect to a multi-lane cable to provide a multi-lane port or connect to a plurality of 1-lane cables to provide a plurality of 1-lane ports.

2. The system of claim 1, wherein the receptacle has two bays, and
wherein the receptacle is to connect to two 1-lane cables to provide two ne ports or connect to one 2-lane cable to provide one 2-lane port.

3. The system of claim 1, wherein the receptacle has four bays, and
wherein the receptacle is to connect to four 1-lane cables to provide four 1-lane ports, connect to two 2-lane cables to provide two 2-lane ports, or connect to one 4-lane cable to provide one 4-lane port.

4. The system of claim 1, wherein each bay of the receptacle comprises a latch area to receive a latch of a cable.

5. The system of claim 1, wherein the receptacle comprises a divider wall between adjacent bays.

6. A system comprising:
a receptacle comprising a joint bay, each bay of the joint bay supporting 1-lane of network communications,
wherein the joint bay is to connect to any one of two 1-lane cables, one 2-lane joint connector finger cable, and one 2-lane split connector finger cable.

7. The system of claim 6, wherein the joint bay comprises contacts in a joint region of the joint bay to support management signals, the contacts to connect to pins in a joint area of the 2-lane joint connector finger cable.

8. The system of claim 6, wherein the joint bay comprises contacts to detect whether a 1-lane cable, a 2-lane cable, or a 4-lane cable is installed.

9. The system of claim 8, wherein the contacts are to connect to presence and low signal pins in a joint area of a 2-lane joint connector finger cable.

10. The system of claim 6, further comprising:
wherein the receptacle comprises a further joint bay; and
a network chip communicatively coupled to the receptacle, the network chip to provide two 1-lane ports in response to the two 1-lane cables being connected to the joint bay, to provide one 2-lane port in response to the one 2-lane joint connector finger cable or the one 2-lane split connector finger cable being connected to the joint bay, and to provide one 4-lane port in response to a 4-lane cable being connected to the joint bay and the further joint bay.

11. A system comprising:
a first system comprising a network chip communicatively coupled to a first receptacle including a plurality of bays, each bay supporting 1-lane of network communications, the first receptacle to connect to a multi-lane cable to provide a multi-lane port or connect to a plurality of 1-lane cables to provide a plurality of 1-lane ports;
a second system comprising a second receptacle to connect to a cable; and
a cable communicatively coupling the first system to the second system via the first receptacle and the second receptacle.

12. The system of claim 11 wherein the first receptacle comprise four bays,
wherein the second receptacle comprises two bays,
wherein the cable is a 2-lane cable, and
wherein the network chip provides a 2-lane port in response to the 2-lane cable.

13. The system of claim 11, wherein the first receptacle comprise four bays,
wherein the second receptacle comprises one bay,
wherein the cable is a 1-lane cable, and
wherein the network chip provides a 1-lane port in response to the 1-lane cable.

14. The system of claim 11 wherein the cable comprises a split connector finger cable, each finger of the split connector finger cable comprising presence and low signal pins to identify the cable to the first system.

15. The system of claim 11, wherein the first receptacle comprises contacts to detect whether a multi-lane cable or a 1-lane cable is installed in the first receptacle, and
wherein the network chip is configured to provide a multi-lane port in response to detecting a multi-lane cable and to provide a 1-lane port in response to detecting a 1-lane cable.
